(19) United States
(12) Patent Application Publication
(10) Pub. No.: US 2013/0337577 A1
(43) Pub. Date: Dec. 19, 2013

(54) Extraction Pipette

(71) Applicant: David R. Pawlowski, Getzville, NY (US)

(72) Inventor: David R. Pawlowski, Getzville, NY (US)

(73) Assignee: CUBRC, INC., Buffalo, NY (US)

(21) Appl. No.: 13/977,290

(22) PCT Filed: Dec. 29, 2011
(86) PCT No.: PCT/US2011/067908

§ 371 Date: Sep. 4, 2013

Related U.S. Application Data
(60) Provisional application No. 61/427,874, filed on Dec. 29, 2010.

(51) Int. Cl. B01L 3/02

(52) U.S. Cl. CPC B01L 3/021
USPC 436/177; 422/501

(57) ABSTRACT

A solid-phase extraction pipette (20) is provided for extracting substances comprising: a generally hollow body (29) having an inlet (21), a stem (22), and an elastic chamber (28); a first extraction media (27) arranged within the hollow body; and a first fit (24) contained within the hollow body and configured to prevent the first extraction media from exiting the body. The body may be made of a transparent material such as low density polyethylene. The chamber may be configured for movement from a first expanded form having a first volume to a second contracted form having a second volume less than the first volume.

### CROSS-REFERENCE TO RELATED APPLICATIONS

The present application claims the benefit of U.S. Provisional Application No. 61/427,874, filed Dec. 29, 2010, which is hereby incorporated by reference in its entirety.

### BACKGROUND OF THE INVENTION

The technical field relates to tools and methods for extraction, and more specifically to efficient tools and methods for the extraction of proteins or nucleic acids from biological samples.

### BRIEF SUMMARY OF THE INVENTION

With reference to the corresponding parts portions or surfaces of the disclosed embodiment, merely for the purposes of illustration and not by way of limitation, the present embodiment provides a pipette (20) for extracting substances comprising: a generally hollow body (29) having an inlet (21), a stem (22), and an elastic chamber (28); a first extraction media (27) arranged within the hollow body; and a first frit (24) contained within the hollow body and configured to prevent the first extraction media from exiting the body. The body may be made of a transparent material such as low density polyethylene. The chamber may be configured for movement from a first expanded form (FIG. 1) having a first volume to a second contracted form (FIG. 3) having a second volume less than the first volume. The chamber may be elastically biased to remain in the first expanded form. The chamber may be configured for movement from the first expanded form to a third folded form in which the elastic chamber is pinched off or isolated from the outside. The hollow body may be tinted and the tint may correspond to a property of the pipette, such as the type of extraction media the pipette contains.

The first frit may be comprised of pores having a size of 10 to 85 microns, and may contain silica or polyethylene. The first frit may be compressively held by the pipette body. The extraction media may be silica-based, alumina-based, or carbon-based. The extraction media may contain silica, borosilicate, nickel, zinc, copper, iron, fibers, or glass. The fibers may be fractionalized nanofibers and/or may contain cellulose. The extraction media may comprise beads, and the beads may have a diameter between 425 and 600 microns. Alternatively, the beads may have a diameter between 150 and 212 microns. The bead diameter may be greater than the pore size of the first frit. The extraction media may be paramagnetic, such as paramagnetic beads. Additionally, the beads may contain a coating and the coating may be configured for BOOM chemistry nucleic acid isoloation, protein isolation with a chaotropic salt, anionic exchange extraction, a metal ion exchange chromatography, or may comprise antibodies. Such a coating may be placed on an extraction media that does not comprise beads.

The pipette may be configured for vortexing its contents, bead beating its contents, and/or grinding. Grinding of pipette contents may be done by squeezing the walls of the hollow body until two walls come together. The pipette stem may contain a grove to encourage the pipette to enter the folded third form and help prevent any contents from exiting the hollow body. The pipette may contain a second frit, arranged such that the extraction media is held between the first frit and the second frit. The pipette may contain a second extraction media and the second extraction media may be arranged to be on a hollow body side of the second frit. The pipette may contain a third frit and the second extraction media may be arranged between the second frit and third frit.

In another aspect, a method is provided for extracting a substance from a sample comprising of the steps of: providing a sample (52); suspending the sample in a liquid; providing a pipette (55) having a generally hollow body with an inlet, a stem, and an elastic chamber, a first extraction media arranged within the hollow body, and a first frit contained within the hollow body and configured to prevent the extraction media from exiting the body; manually compressing (61) the pipette to cause its chamber to deform and contract; allowing (63) the chamber to expand to cause the liquid to pass through the first extraction media whereby the substance preferentially attaches to the extraction media; manually compressing the pipette to cause the liquid to exit the pipette; providing an extraction solution; allowing (66) the chamber to expand and cause the extraction solution to pass through the extraction media, whereby the substance is no longer preferentially attached to said first extraction media and said substance is extracted (95).

The method may further comprise the step of arranging the pipette into a third folded form to cause a contents of the pipette to be constrained within the pipette. The method may further comprise the step of bead beating, vortexing, or grinding the sample. The method may further comprise the step of washing the extraction media with a washing solution or manually compressing the pipette to cause a liquid to exit the pipette. The washing solution may be water, or an alcohol. The method may involve compressing an releasing the pipette to cause air to pass through the first extraction media. The method may also include the step of drying the extraction media or mixing the sample with a binding solution. Such a binding solution may contain a chaotropic salt. The extraction solution used may be a solid-phase extraction solution or a liquid-phase extraction solution. The extraction solution may be an elution solution. The binding solution, elution solution, and extraction media may contain chemistries to perform an extraction protocol for: BOOM chemistry nucleic acid isolation, chaotropic salt protein isolation, cellulose ionic exchange extraction, carboxymethyl cellulose extraction, metal ion exchange chromatography, antibody based extraction/purification, or fractionalized fiber based extraction. The fibers may be nanofibers and may contain cellulose.

The method may use a pipetter with a chamber which is elastically biased to remain in a first expanded form.

In another aspect, a chemical extraction kit is provided which comprises: a pipette having a generally hollow body with an inlet, a stem, and an elastic chamber, an extraction media arranged within the hollow body, and a first frit contained within the hollow body and configured to prevent the extraction media from exiting said body; together with a binding solution; and an extraction solution. The extraction solution may be a solid-phase extraction solution or a liquid-phase extraction solution. The extraction solution may be an elution solution. The kit may further comprise a washing solution. The binding solution, elution solution, and extraction media may contain chemistries to perform an extraction protocol for: BOOM chemistry nucleic acid isolation, chaotropic salt protein isolation, cellulose ionic exchange extraction, carboxymethyl cellulose extraction, metal ion exchange chromatography, antibody based extraction/purification, or fractionalized fiber based extraction. The fractionalized fiber may be nanofiber and may contain cellulose.

The kit may further comprise a substance detector. The substance detector may be an immuno-based assay, a PCR-based assay, an isothermal amplification, or a gel electrophoresis machine. The substance detector may be integrally attached to the pipette.

### BRIEF DESCRIPTION OF THE DRAWINGS

FIG. 1 is a side section view of first embodiment 20.

FIG. 2 is side section view of second embodiment 30.

FIG. 3 is a side view of first embodiment 20 in a compressed form.

FIG. 4 is a side view of first embodiment 20 in a compressed form.

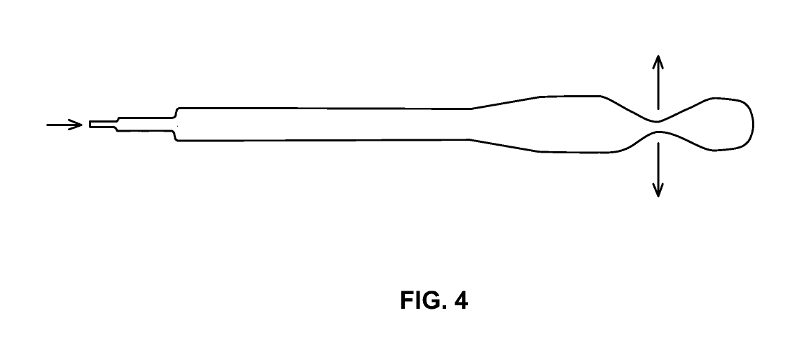

FIG. 5 is a flow chart of a third embodiment for a method of extraction.

FIG. 6 is a side view of a fourth embodiment.

FIG. 7 is a side view of a fifth embodiment.

### DETAILED DESCRIPTION OF THE INVENTION

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

The embodiments provide an efficient tool and method for substance extraction or purification which can be carried out in a non-laboratory or field setting. There is a need for extraction and purification tools which can work with smaller sample sizes and which can be efficiently used without typical laboratory apparatus such as an electronic pipettors and centrifuges. The embodiments are capable of performing an extraction or purification of a variety of compounds. Further, the embodiments provide an extraction or purification method which requires a minimal number of solutions for use, which for many embodiments, such solutions are non-toxic.

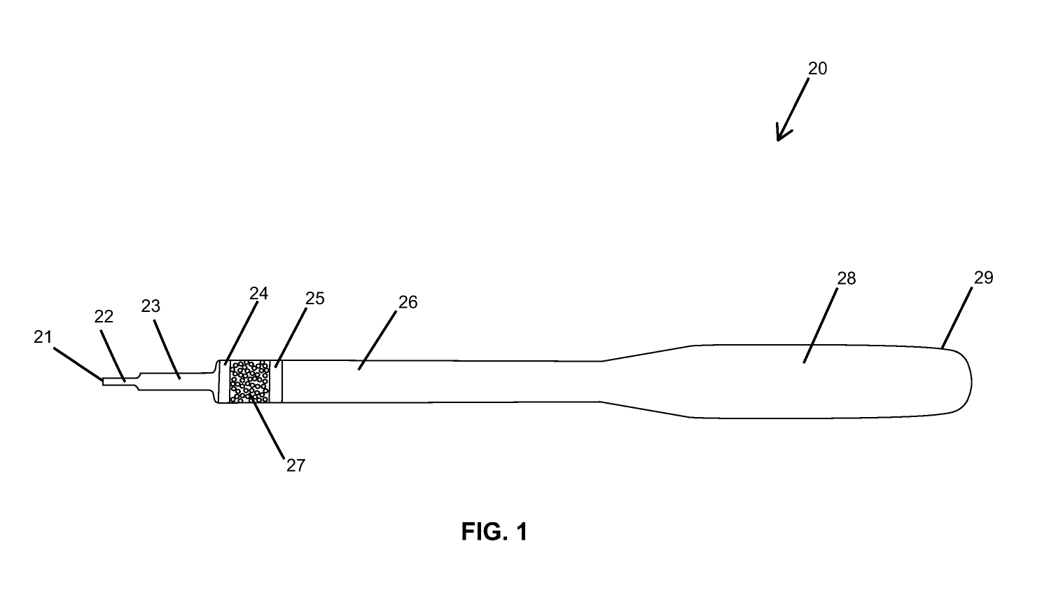

Referring now to the drawings, FIG. 1 shows first embodiment 20 of a pipette for extracting substances in a first expanded form. First embodiment 20 has a generally hollow body 29 made up of inlet 21, stem portions 22, 23, 26, and chamber 28. At the left end of hollow body 29 is circular inlet 21 which communicates to first stem portion 22. First stem portion 22 communicates to second stem portion 23, which communicates to third stem portion 26, which communicates with chamber 28. The stem portions are generally tubular and each successive stem portion, going from left to right, has a generally larger diameter than the previous stem portion. Chamber 28 is generally cylindrical.

Hollow body 29 is made of low density polyethylene and is elastic. Hollow body 29 is transparent and tinted pink. The tint color corresponds to the type of extraction media used.

As shown within FIG. 1, within the left side of third stem portion 26 are arranged first frit 24, extraction media 27, and second frit 25. A frit is a porous matrix, or mesh, such as a filter, or mass of beads or particles. First frit 24 and second frit 25 are a porous mesh made of polyethylene. The mesh is made of particles with a size between 10 to 85 microns. It is important that the mesh is constructed such that it does not have a pore size that would allow substances with a diameter of 50 microns or larger to pass through. First frit 24 and second frit 25 are circular and are compressively held within third stem portion 26.

Extraction media 27 is made up of silica beads with a diameter greater than 50 microns. Alternatively, extraction media 27 may be other silica-based compounds, or may be alumina-based, or carbon-based. The extraction media may contain borosilicate, nickel, zinc, copper, iron, fibers, or glass, and may also contain a coating configured for BOOM chemistry nucleic acid isoloation, protein isolation with a chaotropic salt, anionic exchange extraction, a metal ion exchange chromatography, or may comprise antibodies. The key function of extraction media 27 is to preferentially attach to or bind to a desired substance in the presence of a first solution, and to not preferentially attach or bind the substance in the presence of a second solution. Extraction media 27 is held between first frit 24 and second frit 25. In first embodiment 20, extraction media 27 should completely fill the volume between first frit 24 and second frit 25.

The volume in chamber 28 should be significantly larger than the combined volume of stem portions 1 and 2.

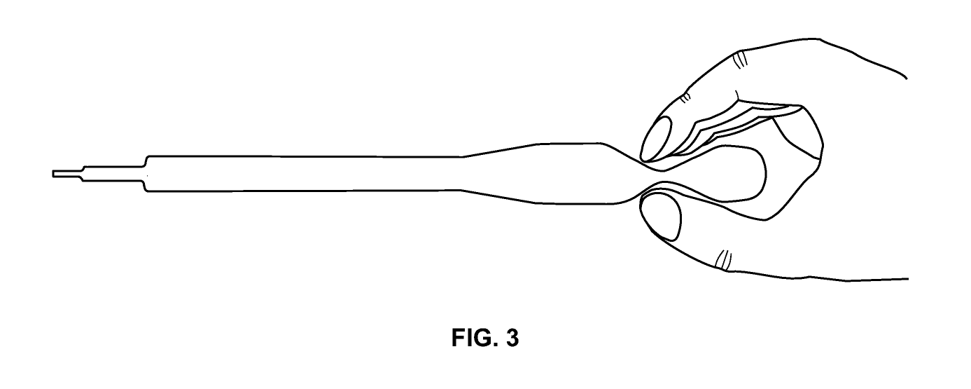

Embodiment 20 generally operates by providing an elastic chamber which can manually be activated as a pipettor for suction and pumping, and by providing an embedded extraction media for which the relative affinity to various substances such as nucleic acids and proteins in a solution are varied. FIG. 3 shows first embodiment 20 in a second compressed form. By manually squeezing chamber 28, embodiment takes on the second compressed form, in which the volume of chamber 28 is significantly decreased compared to chamber 28's volume in the expanded form shown in FIG. 1. A significant portion of the fluid in stem portion 26 and chamber 28 is forced through frit 25, extraction media 27, frit 24, and out the inlet as chamber 28 is compressed.

When the manual grip on chamber 28 is released, the elastic properties of the polyethylene body causes embodiment 20 to return to its default expanded form, sucking fluid in through the inlet during the process. A portion of the fluid sucked into the inlet is forced through frit 24, extraction media 27, and frit 25.

Any liquid that is in the fluid sucked into embodiment 20 may be directed into chamber 28 by orienting the device with inlet 21 pointed upwards. In this orientation, embodiment 20 may optionally be vortexted. Additionally, in this orientation it is easy to hold the device in one hand and use one's index finger to bend stem portion 22 or 23 to prevent the escape of fluid, and then shake the apparatus in order to mix the contents. Alternatively, embodiment 20 may be folded along stem portion 26 in order to cause stem portion 26 to pinch closed, preventing any liquid in chamber 28 from escaping within embodiment 20. While embodiment 20 is held with inlet 21 facing upwards, a user may squeeze the sides of chamber 28 together, and forcibly grind any solid contents caught between the walls of chamber 28.

The described embodiment resulted in several unexpected advantages. Embodiment 20, fulfills the roles of a pipettor, a pipette, an extraction media, a mixing tube, and storage tube. Embodiment provides a highly efficient, compact, and mobile system for performing extractions for a number of substances. Various other embodiments are also possible.

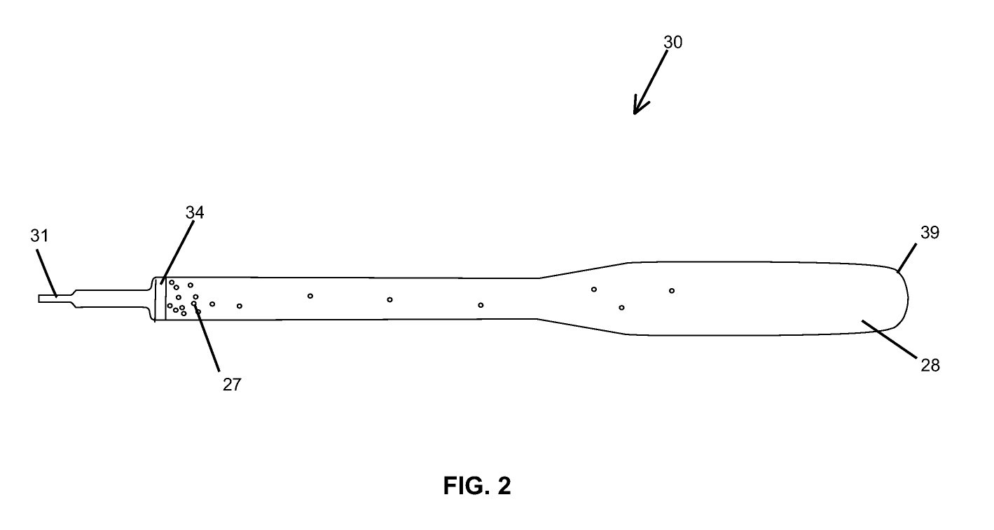

FIG. 2 shows second embodiment 30 which contains only a single frit 34. As shown, extraction media 27, which is comprised of beads, is allowed to freely move in stem portion 36 and chamber 38. Cells may be contained in a fluid which is suctioned into the device. When embodiment 20 is shaken to mix such contents containing cells, the beads within extraction media 37 are free to move and cause a “bead beating” effect, in which they aid in lysing the cells. The bead beating effect is more pronounced when the apparatus is vortexed. Additionally, since extraction media 37 is free to enter chamber 38, when embodiment 30 is oriented with inlet 21 in the air, extraction media 37 beads will aggregate in chamber 38. This is useful when a sample is sucked into embodiment 30 and it is advantageous to allow the sample to have extended contact with the surface of extraction media 37, and thus incubate the sample for a duration of time.

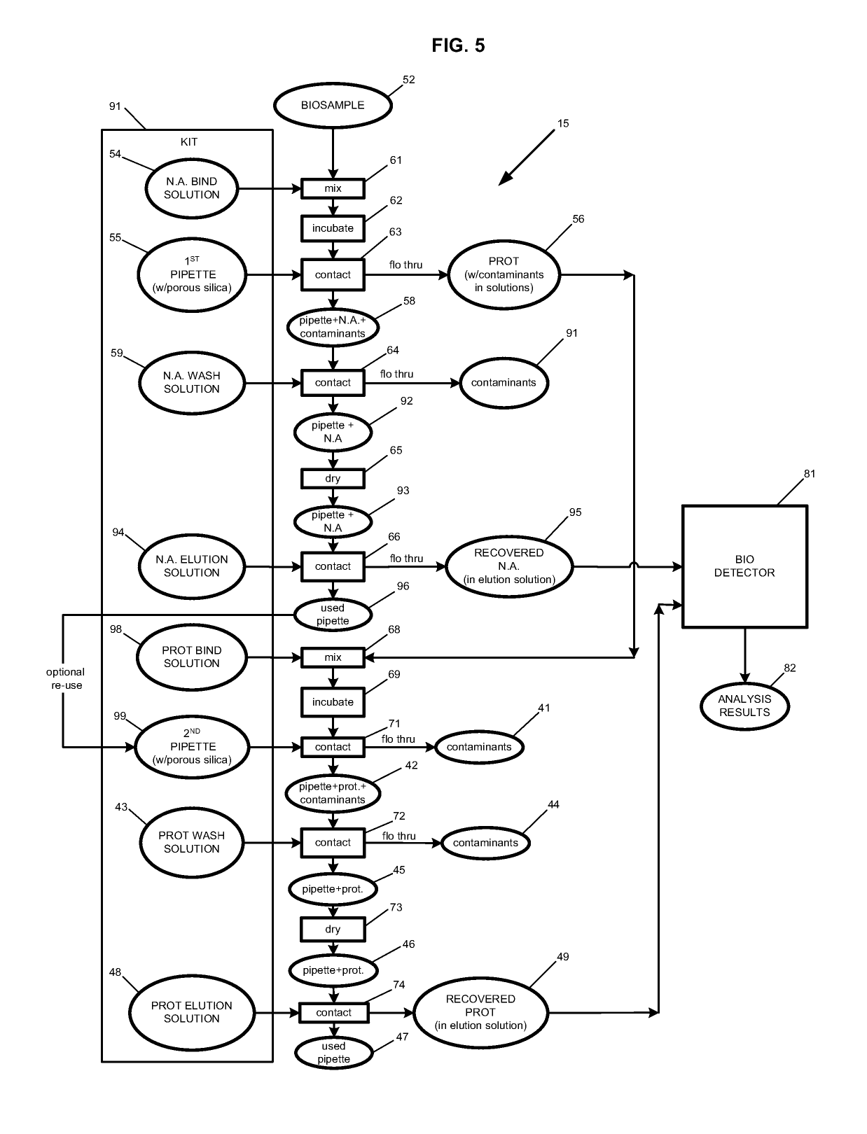

As shown in FIG. 5, third embodiment 15, is disclosed generally providing a method to extract protein and nucleic acids from a biological sample, without the use of a separate pipettor, centrifuge, or toxic solutions.

As shown in FIG. 5, biological sample 52 is provided. Biological sample 52 should contain at least one protein or at least one nucleic acid, and it may be in the form of cells or viruses.

Nucleic acid binding solution 54 is then provided. The nucleic acid binding solution should effectively increase the affinity of nucleic acid to extraction media 27 and/or decrease the solubility of the nucleic acid. Nucleic acid binding solution 54 also contains a chaotropic agent. In this embodiment, the chaotropic agent is guanidine thiocyanate at a concentration of 6 M. Alternatively, chaotropic agents such as urea or lithium perchlorate may be used. The chaotopic agent should disrupt the structure of molecules in the biological sample by interrupting hydrogen bonding, Van der Waals interactions, and hydrophobic effects. The nucleic acid binding solution may include a chaotropic agent combined with other compositions. For example, nucleic acid binding solution 54 may include a lysate to lyse cell membranes in biological sample 52.

Biological sample 52 is then mixed 61 with nucleic acid binding solution 54. Extraction pipette 55 is provided, which is equivalent to second embodiment 30 described above. Sample 52 and nucleic acid binding solution may be mixed by squeezing chamber 38 of extraction pipette 55, placing inlet 31 into the container holding nucleic acid binding solution 54 and sample 52, and then releasing the chamber, causing sample 52 and solution 54 to be drawn into chamber 38. Extraction pipette 55 is then placed upside down, stem portion 22 or 23 is bent, pinching off the passage to prevent fluid escape, and extraction pipette 55 is shaken to allow mixing of sample 52 and solution 54. Because the particle size of first frit 34 and second frit 35 in extraction pipette 55 is controlled to be between 10 and 85 microns, the pores created are large enough to allow cells in the biological sample 52 to pass through. Cells in sample 52 may be lysed by the bead beating effect of the silica beads in extraction media 37 of extraction pipette 55. The mixture is optionally incubated 62 for a period of time, allowing sample 52 to have extended contact with extraction media 37. Extraction media 37 should be configured to reversibly bind nucleic acid. In this embodiment, extraction media 37 is silica beads, which is known to reversibly bind nucleic acid.

In this manner, the nucleic acids from biological sample 52 become bound to silicate pipette 55 as indicated at 58 and are thereby removed from and are no longer in solution. The proteins from the biological sample remain in the flow through solution 56 of the mixture. Flow through solution 56, hereafter referred to as nucleic acid binding flow through 56, is separated from the silicate pipette and used for protein extraction as described below.

Nucleic acid wash solution 59 is then suctioned into extraction pipette 55 by compressing and releasing chamber 38. Wash solution 59 helps remove any impurities which may be clinging to the silica beads or which are present in solution that remains bound to the silica beads by surface adhesion. In this embodiment, a mixture of ethanol and acetone is used as the nucleic acid wash solution. The extraction pipette may be shaken or vortexed one the wash solution is inside. After washing, extraction pipette containing nucleic acid 93 may be dried.

Next, nucleic acid elution solution 94 is contacted 66 with silicate pipette tip 93. In this embodiment, a mixture of water and salt is used as the nucleic acid elution solution. Nucleic acids have a higher affinity to the nucleic acid elution solution than to silica, causing the nucleic acids to unbind from the silica frit and enter the solution. Resulting solution 95 is then collected, thereby recovering nucleic acids isolated from original biological sample 52. The recovered nucleic acid may subsequently be used in biodetector 81. This nucleic acid isolation procedure has equivalent performance characteristics to the current nucleic acid isolation gold standard and the isolated nucleic acids are compatible with all tested downstream PCR-based detection platforms.

The proteins are extracted from nucleic acid binding flow through 56 collected earlier as follows. Protein binding solution is first suctioned into extraction pipette 99 (the same extraction pipette from the nucleic acid extraction phase may be used or a new extraction pipette may be used). Protein binding solution 98 is a binding or precipitating agent that is adapted to assist in extracting protein from solution when it comes into contact with the silica beads. Nucleic acid binding flow through 56 is mixed 68 with protein binding solution 98 by suctioning it into extraction pipette 99. The mixture is shake and allowed to incubate inlet side up. The incubation 69 should last less than 60 minutes. In certain applications, the incubation can be as short as five minutes or less without materially diminishing the efficacy of the process. While an incubation period of less than five minutes may be used, the effectiveness of protein binding solution 98 may decrease with shorter incubation periods. In this embodiment, protein binding solution 98 is isopropanol mixed with 2.5% sodium dodecyl sulfate and glycogen. Alternatively, other compounds may be used as the protein binding solution, such as isopropanol, ethanol, trichloroacetic acid, acetone or methanol. It is also often beneficial to have the protein binding solution include a precipitating catalyst. In this embodiment, glycogen acts as a precipitating catalyst in protein binding solution 98. The protein binding solution may also include a detergent. Examples of detergents which may be used include sodium dodecyl sulfate, polyoxyethylene sorbitan monooleate, and polyethylene glycol p-(1,1,3,3-tetramethylbutyl)-phenyl ether.

After incubation 69, the mixture is again contacted 71 with extraction media 37 in pipette 99, which should be configured to reversibly bind a protein.

As described above, shaking and vortexting is used to contact the mixture the silica beads of extraction media 37. Flow through 41 is discarded. Protein wash solution 43 is then suctioned into extraction pipette 99 and mixed to remove any impurities which may be clinging to the silica or which are present in any solution remaining bound to the silica beads due to surface adhesion. In this embodiment, isopropanol is used as protein wash solution 43. Wash solution 43 discarded after mixing. After washing, extraction pipette containing protein 45 may be dried 73.

Proteins are removed from dried extraction pipette 46 using protein elution solution 48, to which the proteins have a higher affinity than silica. In this embodiment, protein elution solution 48 is a mixture of water and salt. A detergent may also be added to the protein elution solution, such as sodium dodecyl sulfate, polyoxyethylene sorbitan monooleate, and polyethylene glycol p-(1,1,3,3-tetramethylbutyl)-phenyl ether. Protein elution solution 48 is passed through 74 silicate pipette tip 46 several times with the pipettor, causing the proteins to unbind from the silica frit and enter the solution. Resulting solution 49 is then collected, thereby recovering the proteins isolated from the rest of the original biological sample. As shown in Example 1 below, the process unexpectedly results in the extraction of a majority of the protein in the original sample and on average results in extraction of greater than 70% of the protein. Recovered protein 49 may be subsequently used in biodetector 81.

The described method resulted in a number of unexpected results. First, the process isolates both nucleic acids and protein from a sample without splitting the sample and without extraneous laboratory equipment. The process is a rapid one, allowing for isolation in less than 30 minutes. The process can be conducted in an in-line format, first isolating nucleic acids from the sample immediately followed by protein isolation, with nucleic acid clean-up and recovery occurring concurrent with protein isolation. The process is capable of isolating the majority of protein in a sample, with an average of 73%, and the recovered protein is immunoreactive. Thus, the process provides a means to rapidly isolate the two most prominent macromolecular classes of biological agent identifiers for use with the majority of downstream analyzers, thereby providing the user increased confidence in test results. Finally, the process extracts nucleic acids and protein from the same biological sample in high yield, without the use of dangerous reagents, and without the use of sophisticated laboratory equipment such as a centrifuge or a separate pipettor. The embodiment results in an all-in-one device and method in which all that is needed is a single extraction pipette and the appropriate non-toxic solutions.

The invention also provides a kit, the embodiment which is shown in FIG. 5 at 91. The kit may be used to quickly isolate nucleic acids and/or protein from a biological sample without the need for a centrifuge, separate pipettor, or other expensive laboratory equipment. In the preferred embodiment, the kit generally comprises a nucleic acid binding solution, a protein binding solution, and an extraction pipette identical to embodiment 30. The nucleic acid binding solution may be made up of a chaotropic agent only, or a chaotropic agent mixed with other elements. In this embodiment, the chaotropic agent is selected from the group consisting of urea, guanidine salts and lithium perchlorate, and includes a detergent, such as sodium dodecyl sulfate, polyoxyethylene sorbitan monooleate, and polyethylene glycol p-(1,1,3,3-tetramethylbutyl)-phenyl ether. In this embodiment, the protein binding solution includes a precipitating agent, and the precipitating agent is an alcohol such as isopropanol, ethanol or methanol. Alternatively, the precipitating agent may be trichloroacetic acid or acetone. The protein binding solution may also include a precipitating catalyst and a detergent. In this embodiment, the precipitating catalyst is glycogen.

The kit may also include a nucleic acid elution solution and a protein elution solution, such as water and a salt. The porous silica compound may be in a silica syringe filter, a silica matrix, a silica frit, a silica particulate column, a silicate pipette tip or borosilicate. The kit does not need to include a centrifuge or pippettor.

A number of variations of the above embodiments are possible. For example, various different types of extraction media may be used including: borosilicate, nickel, zinc, copper, iron, fractionalized nanofibers, glass, paramagnetic material, antibody coated material, or metal ion exchange exchange chromatography media such as nickel exchange antibodies. The extraction media may be in bead form, having diameters of 150-212 microns, 425-600 microns, or a size greater than 50 microns. The advantages of the various size ranges are efficiency of extraction due to surface area, efficacy of beat beating, and variable flow resistance. The extraction media may be in matrix form, or in a compressed powder form. Each of the various extraction media chemistries can be matched with a color tint applied to the extraction pipette body.

Additionally, various additional chemistries for the solutions used may be employed such as: BOOM chemistry nucleic acid isolation, protein isolation with a chaotropic salt, anionic exchange extraction, metal ion exchange chromatography, or antibody based extraction/purification.

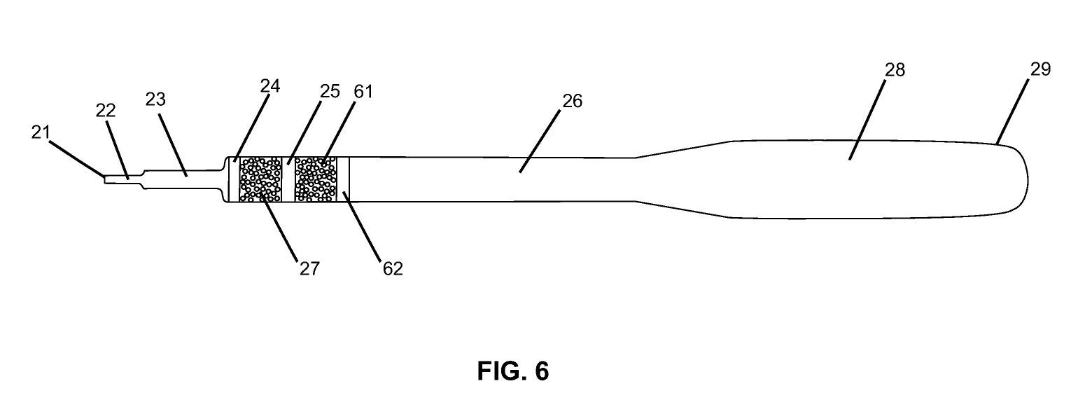

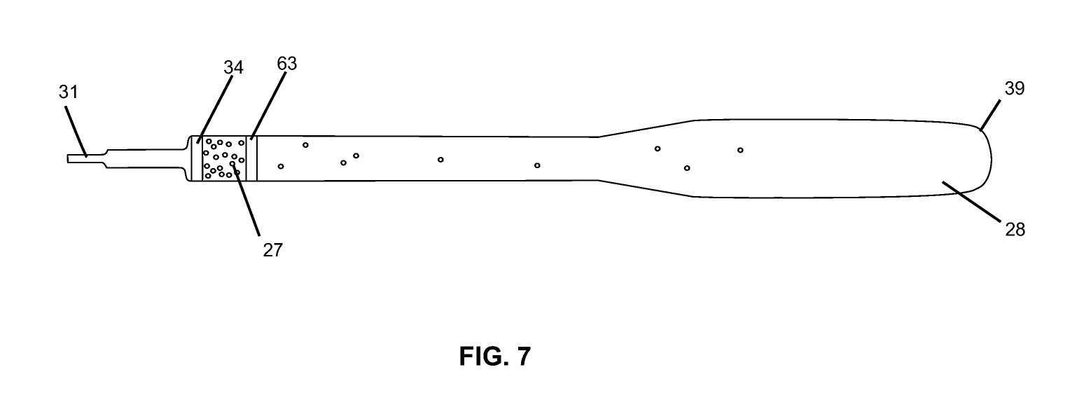

Additional fits and additional extraction media may be used in a single pipette. For example, FIG. 6 shows an embodiment having a third frit 62 for holding a second extraction media 61. FIG. 7 shows another embodiment in which a second extraction media is allowed to enter chamber 28 and aid in bead beating as described previously.

Therefore, while the presently-preferred form of the extraction pipette and method of extraction has been shown and described, and several modifications thereof discussed, persons skilled in this art will readily appreciate that various additional changes may be made without departing from the spirit of the invention, as defined and differentiated by the following claims.

1. An extraction pipette comprising:
a generally hollow body, comprising:
an inlet;
a stem;
an elastic chamber;
a first extraction media arranged within said hollow body; and
a first frit contained within said hollow body configured to prevent said first extraction media from exiting said hollow body, and wherein said first frit is compressively held by said hollow body.

2. The pipette of claim 1, wherein said hollow body is comprised of a transparent material, low density polyethylene, or is tinted or any combination thereof.

3. (canceled)

4. The pipette of claim 1, wherein said chamber is elastically configured for movement from an first expanded form having a first volume to a contracted form having a second volume less than said first volume.

5-6. (canceled)

7. The pipette of claim 1, wherein said first frit comprises silica, polyethylene, or 10 to 85 micron size pores or any combination thereof.

8-9. (canceled)

10. The pipette of claim 1, wherein said first extraction media is silica-based, alumina-based, or carbon-based.

11. The pipette of claim 1, wherein said first extraction media comprises beads, silica, borosilicate, nickel, zinc, copper, iron, fractionalized nanofibers, or glass.

12. (canceled)

13. The pipette of claim 11 wherein said beads have a diameter from about 150 to 212 microns, are paramagnetic or comprise a coating, or any combination thereof.

14-15. (canceled)

16. The pipette of claim 13, wherein said coating is configured for BOOM chemistry nucleic acid isolation, protein isolation using a chaotropic salt solution, anionic exchange extraction, metal ion exchange chromatography, or affinity based chromatography.

17. The pipette of claim 1 wherein the pipette is configured for vortexing, grinding, pinching, or bead beating contents therein.

18-20. (canceled)

21. The pipette of claim 1, further comprising a second frit arranged such that the first extraction media is between said first frit and said second frit.

22. The pipette of claim 1, further comprising a second extraction media.

23. The pipette of claim 21 further comprising a third frit and a second extraction media arranged between said second frit and said third frit.

24. Method of extracting a substance comprising:
providing a sample;
suspending said sample in a liquid;
providing a pipette comprising:
a generally hollow body having:
an inlet;
a stem;
an elastically biased chamber;
a first extraction media arranged within said hollow body; and
a first frit contained within said hollow body and configured to prevent said first extraction media from exiting said hollow body;
compressing said pipette;
allowing said chamber to expand to cause said liquid to pass through said first extraction media, wherein said substance interacts with said first extraction media;
compressing said pipette to cause said liquid to exit said pipette;
providing an extraction solution;
allowing said chamber to expand, wherein said extraction solution passes through said extraction media, wherein said substance no longer interacts with said first extraction media and said substance is extracted.

25. The method of claim 24, further comprising folding said pipette to cause contents therein to be constrained or squeezing said hollow body to grind the contents therein or bead beating or vortexing said sample, or any combination thereof.

26-28. (canceled)

29. The method of claim 24 further comprising washing said extraction media with a washing solution after said compressing.

30. The method of claim 24 further comprising compressing and releasing said pipette to cause air to pass through said first extraction media.

31. The method of claim 24 further comprising mixing said sample with a binding solution, wherein said binding solution comprises a chaotropic salt.

32. (canceled)

33. The method of claim 24, wherein said extraction solution is a solid-phase extraction solution or a liquid-phase extraction solution.

34. (canceled)

35. The method of claim 24 further comprising mixing said sample with a binding solution and contacting an elution solution with said extraction media wherein said binding solution, said elution solution, and said extraction media provide for an extraction selected from the group consisting of: BOOM chemistry nucleic acid isolation, chaotropic salt protein isolation, cellulose ionic exchange extraction, carboxymethyl cellulose extraction, metal ion exchange chromatography, affinity based chromatography, or fractionalized fiber based extraction.

36. (canceled)

37. An extraction kit comprising:
a pipette comprising:
a generally hollow body having:
an inlet;
a stem;
and an elastic chamber;
an extraction media arranged within said hollow body; and
a first frit contained within said hollow body and configured to prevent said extraction media from exiting said body;
a binding solution; and
an extraction solution.

38-43. (canceled)
